(19) United States
(12) Patent Application Publication
(10) Pub. No.: US 2020/0209442 A1
(43) Pub. Date: Jul. 2, 2020

(54) Reticulated Reflective Material

(71) Applicant: 3M INNOVATIVE PROPERTIES COMPANY, St. Paul, MN (US)

(72) Inventors: Anne C. Gold, South St. Paul, MN (US); Silvia G. B. Guttmann, St. Paul, MN (US); Thomas J. Gilbert, St. Paul, MN (US); Corey D. Voelker, Ellsworth, WI (US); Bernerd A. Koch, St. Paul, MN (US)

(21) Appl. No.: 16/642,097

(22) PCT Filed: Aug. 30, 2018
(86) PCT No.: PCT/IB2018/056640

§ 371 Date: Feb. 26, 2020

Related U.S. Application Data
(60) Provisional application No. 62/553,462, filed on Sep. 1, 2017.

(51) Int. Cl. G02B 5/08; B32B 3/26; B32B 7/12; A41D 13/01

(52) U.S. Cl. CPC G02B 5/0808; A41D 13/01; B32B 7/12; B32B 3/26

(57) ABSTRACT

There is provided a reticulated reflective article, having a longitudinal direction and a width direction, comprising: a plurality of strands of a reflective material attached to one another at bridging regions in the reflective material and separable from one another between the bridging regions to provide openings in the reflective material, wherein the openings are expandable in at least one direction to provide a variably expandable area, and wherein the reflective materials comprises a reflective major surface and a non-reflective major surface, wherein each of the openings has a longitudinal dimension, a width dimension, and each of the plurality of strands has a thickness, and wherein the reticulated reflective article is expandable in at least both of the longitudinal direction and the width direction. There is also provided a reticulated reflective article, wherein the reticulated reflective article is expandable in at least two directions.

### FIELD

This disclosure relates to reflective material, and more particularly reticulated reflective material for use on protective garments.

### BACKGROUND

Reflective materials have been developed for use in a variety of applications, including road signs, license plates, footwear, and clothing patches to name a few. Reflective materials are often used as high visibility trim materials in clothing to increase the visibility of the wearer. For example, reflective materials are often added to protective garments worn by firefighters, rescue personnel, EMS technicians, and the like.

Retroreflectivity can be provided in a variety of ways, including by use of a layer of tiny glass beads or microspheres that cooperate with a reflective agent, such as a coated layer of aluminum. The beads can be partially embedded in a binder layer that holds the beads to fabric such that the beads are partially exposed to the atmosphere. Incident light entering the exposed portion of a bead is focused by the bead onto the reflective agent, which is typically disposed at the back of the bead embedded in the binder layer. The reflective agent reflects the incident light back through the bead, causing the light to exit through the exposed portion of the bead in a direction opposite the incident direction. Reflective materials can be particularly useful to increase the visibility of fire and rescue personnel during nighttime and twilight hours. In some situations, however, firefighter garments can be exposed to extreme temperatures during a fire, causing the reflective material to trap heat inside the garment. Under certain conditions, the trapped heat can result in discomfort or even burns to the skin of the firefighter.

In particular, moisture collected under the reflective material may expand rapidly when exposed to the extreme temperature from the fire. If the expanded moisture is unable to quickly permeate through the reflective material, the firefighter can be exposed to extreme temperatures. In some cases, this can result in steam burns on the skin of the firefighter underneath the portions of the garment having the reflective material. Conventional reflective materials, including perforated reflective materials generally exhibit this phenomenon. For example, conventional perforated reflective materials include standard reflective trim having needle punched holes, laser punched holes, slits, or relatively large holes made with a paper punch.

### SUMMARY

There is a need for reflective articles that are expandable in two or more directions to provide varying levels of brightness and varying degrees of breathability or air/moisture permeability. In general, this disclosure describes reticulated reflective material for use on protective garments that satisfy the aforementioned needs.

In one aspect, there is provided a reticulated reflective article, comprising: a plurality of strands of a reflective material attached to one another at bridging regions in the reflective material and separable from one another between the bridging regions to provide openings in the reflective material, wherein the openings are expandable to provide a variably expandable area, and wherein the reflective materials comprises a reflective major surface and a non-reflective major surface, wherein each of the openings has a longitudinal dimension, a width dimension, and each of the plurality of strands has a thickness, and wherein the reticulated reflective article is expandable in at least both of a longitudinal direction and a width direction.

In some embodiments, the article provides a first reflective brightness when separated into a first width dimension between the plurality of strands of reflective material and a second reflective brightness when separated into a second width dimension between the plurality of strands of reflective material. In some embodiments, the reduction in brightness between the first reflective brightness and the second reflective brightness is from at least about 10% reduction in brightness to about a 90% reduction in brightness, wherein both brightnesses are determined according to ASTM E810-03 (2013) when performed on unwashed reticulated reflective articles.

In some embodiments, the change in open area from the first width dimension to the second width dimension is at least 20%, the reduction in brightness between the first reflective brightness and the second reflective brightness is from at least 25% reduction in brightness to about a 90% reduction in brightness, wherein both brightnesses are determined according to ASTM E810-03 (2013) when performed on unwashed reticulated reflective articles, and further wherein the reticulated reflective article has a permeability of at least 5.5 cm/s. In some embodiments, the article provides a first reflective brightness when separated into a first width dimension between the plurality of strands of reflective material having an adhesive layer disposed thereon and a second reflective brightness when separated into a second width dimension between the plurality of strands of reflective material having an adhesive layer disposed thereon. In some embodiments, the first width dimension is less than the second width dimension. In some embodiments, the first reflective brightness is higher than the second reflective brightness.

In some embodiments, non-reflective regions comprise at least 25% of the total surface area of the reflective material. In some embodiments, non-reflective regions comprise at least 50% of the total surface area of the reflective material.

In some embodiments, the reticulated reflective articles further comprise a carrier tape adhered to the reflective major surface of the reflective material. In some embodiments, the reticulated reflective articles further comprise an adhesive layer disposed on one of the major surfaces of the reflective material, wherein the adhesive layer is separable into a plurality of strands disposed on the plurality of strands of the reflective material. In some embodiments, the reticulated reflective articles further comprise a substrate disposed on a major surface of the adhesive layer opposite the reticulated reflective article. In some embodiments, the substrate is elastomeric.

In some embodiments, the article has a first brightness when it is in a non-expanded form and a second brightness when it is in an expanded form. In some embodiments, the article has a first permeability when it is in a non-expanded form and a second permeability when it is in an expanded form. In some embodiments, the reflective material is selected from at least one of optical films, microprismatic film and microsphere films.

In another aspect, the present disclosure provides a reticulated reflective article, having a longitudinal direction and a width direction, and comprises: a plurality of regions of a reflective material separable from one another to provide openings in the reflective material, wherein the reflective materials comprises a reflective major surface and a non-reflective major surface, wherein each of the openings has a longitudinal dimension, and a width dimension, and wherein the reticulated reflective article is expandable in at least two directions. In some embodiments, the articles further comprise a multitude of the plurality of regions extending radially from a common intersection.

In another aspect, the present disclosure provides a reflective article having at least a longitudinal dimension and a width dimension and comprises: a reflective layer comprising optical film, microprismatic film, microsphere film, or combinations thereof having a plurality of slits formed therein, the plurality of slits having a slit direction and each slit having a top and an opposing bottom direction along the slit direction, the slit direction being at least substantially parallel to the longitudinal dimension or the width dimension, the plurality of slits comprising at least two adjacent slits offset with respect to an axis perpendicular to the slit direction, wherein the top of and bottom of at least two adjacent slits are not greater than 40 mm apart along the slit direction when the reflective article is in a pre-stretched condition.

In some embodiments, the article provides a first reflective brightness when separated into a first width dimension between the plurality of regions of reflective material and a second reflective brightness when separated into a second width dimension between the plurality of regions of reflective material. In some embodiments, the reduction in brightness between the first reflective brightness and the second reflective brightness is from about 10% reduction in brightness to about a 90% reduction in brightness, wherein both brightnesses are determined according to ASTM E810-03 (2013) when performed on unwashed reticulated reflective articles. In some embodiments, the change in open area from the first width dimension to the second width dimension is at least 20%, the reduction in brightness between the first reflective brightness and the second reflective brightness is from at least 25% reduction in brightness to about a 90% reduction in brightness, wherein both brightnesses are determined according to ASTM E810-03 (2013) when performed on unwashed reticulated reflective articles, and further wherein the reticulated reflective article has a permeability of at least 5.5 cm/s. In some embodiments, the article provides a first reflective brightness when separated into a first width dimension between the plurality of regions of reflective material having an adhesive layer disposed thereon and a second reflective brightness when separated into a second width dimension between the plurality of regions of reflective material having an adhesive layer disposed thereon. In some embodiments, the first reflective brightness is higher than the second reflective brightness.

In some embodiments, the reticulated reflective articles further comprise a carrier tape adhered to the reflective major surface of the reflective material. In some embodiments, the reticulated reflective articles further comprise an adhesive layer disposed on one of the major surfaces of the reflective material, wherein the adhesive layer is separable into a plurality of regions disposed on the plurality of regions of the reflective material. In some embodiments, the reticulated reflective articles further comprise a substrate disposed on a major surface of the adhesive layer opposite the reticulated reflective article. In some embodiments, the substrate is elastomeric.

In some embodiments, the article has a first brightness when it is in a non-expanded form and a second brightness when it is in an expanded form. In some embodiments, the article has a first permeability when it is in a non-expanded form and a second permeability when it is in an expanded form. In some embodiments, the reflective material is selected from at least one of optical films, microprismatic film and microsphere films.

Additional details of these and other embodiments are set forth in the accompanying drawings and the description below. Other features, objects and advantages will become apparent from the description and drawings, and from the claims.

### BRIEF DESCRIPTION OF THE DRAWINGS

FIGS. 1A to 4B, 12A and 12 B depict the presently disclosed reticulated reflective material having a diamond slit pattern in variety of degrees of size and expansion.

FIGS. 5A, 5B, 8A, 8B, 10A, 10B, 11A, 11B, 14A and 14B depict non-diamond slit patterns that provide expansion of the reticulated reflective articles in at least one direction.

FIGS. 6A, 6B, 15A and 15B depict reticulated reflective articles having two different size and/or shape openings that provide expansion of the reticulated reflective articles in at least one direction.

FIGS. 7A, 7B, 9A, 9B, 13A and 13B depict reticulated reflective articles having three different size and/or shape openings that provide expansion of the reticulated reflective articles in at least one direction.

FIGS. 16A, 16B, 18A and 18B depict reticulated reflective articles having two different size and/or shape openings that provide expansion of the reticulated reflective articles in at least two directions.

FIGS. 17A, 17B an 17C depict reticulated reflective articles having a multitude of a plurality of expandable retroreflective regions that provide expansion of the reticulated reflective articles in at least two directions, such as radial expansion.

FIGS. 19A and 19B depict reticulated reflective articles having three different size and/or shape openings that converge to provide expansion of the reticulated reflective articles in at least three directions.

FIG. 20 depicts a cross section of the presently disclosed retroreflective article.

FIGS. 21A, 21B and 21C depict reflective articles demonstrating certain characteristics of slit patterns seen in some disclosed embodiments.

### DETAILED DESCRIPTION

In general, this disclosure describes reticulated reflective material for use on protective garments. The material may include a non-continuous reflective pattern that provides a high-level of reflective brightness, yet provides adequate permeability to prevent exposure to heated moisture and extreme temperatures.

In some cases, this disclosure describes the garment itself, i.e., an outer layer or outer shell of a protective outfit. In other cases, this disclosure describes an article, such as a clothing patch that could be added to a protective garment. In still other cases, this disclosure describes a protective outfit that includes the non-continuous reflective pattern on an outer shell and additional layers such as a thermal liner and a moisture barrier.

The terms “articles” and “reticulated reflective articles” are used interchangeably herein.

The term “elastomeric” as used herein means comprised of any material that is able to resume its original shape when deforming forces are removed.

The term “reflectivity” as used herein means redirection of light from a given material. The term “retroreflection” as used herein means reflection of light back toward the light source from a given material. The terms “reflectivity” and “retroreflectivity” are used interchangeably herein.

The term “reticulated” as used herein means a net like formation of strands or regions that are joined at certain points.

Disclosed articles include a reflective layer or a reflective material. Useful reflective layers or reflective materials can include 3M™ SCOTCHLITE™ Reflective Material—C790 Carbon Black Stretch Transfer Film from 3M Company (St. Paul, Minn.).

In some embodiments, the present disclosure provides a reticulated reflective article having a longitudinal direction and a width direction, and including a plurality of strands of a reflective material attached to one another at bridging regions in the reflective material and separable from one another between the bridging regions to provide openings in the reflective material, where the openings provide a variably expandable area, and where the reflective material comprises a reflective major surface and a non-reflective major surface, also where each of the openings has a longitudinal dimension, a width dimension, and each of the plurality of strands has a thickness, and also where the reticulated reflective article is expandable in at least two directions.

In the present disclosure, expansion of the reticulated reflective article is considered as a change in the area of the openings in the reticulated reflective article. Presently disclosed reticulated reflective articles can provide varying amounts of open area when expanded in one or more directions. As the reticulated reflective articles are expanded the amount of open area is increased, resulting in lower brightnesses and increased permeabilities. In some embodiments, expansion can be conducted before the reticulated reflective article is mounted on a substrate. In some embodiments, expansion occurs due to motion of a user, such as for example, when the reticulated reflective article is mounted on a biomotion point, for example an elbow or knee region of active wear.

Disclosed reticulated retroreflective articles can be useful when disposed on biomotion points as they can create a different retroreflective pattern when disposed and/or stretched over a biomotion point as that biomotion point moves and/or is articulated. The different retroreflective pattern when disposed over a biomotion point can make the article or a wearer wearing the retroreflective article more conspicuous which can be advantageous for increased safety of the wearer. Metropolitan roadway scenes, for example, can have many light sources. As nighttime visual environments become increasingly visually cluttered, there is a growing need for conspicuity solutions that differentiate pedestrians from other environmental stimuli. Visual attention modeling of dynamic visual scenes has demonstrated that motion and/or flashing has a higher likelihood of capturing visual attention than static light sources.

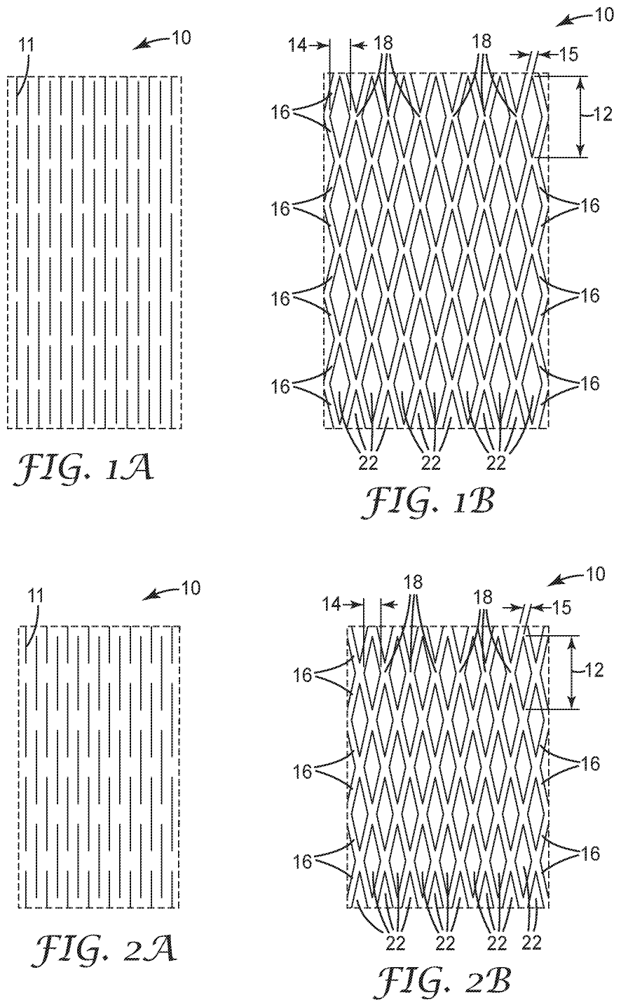

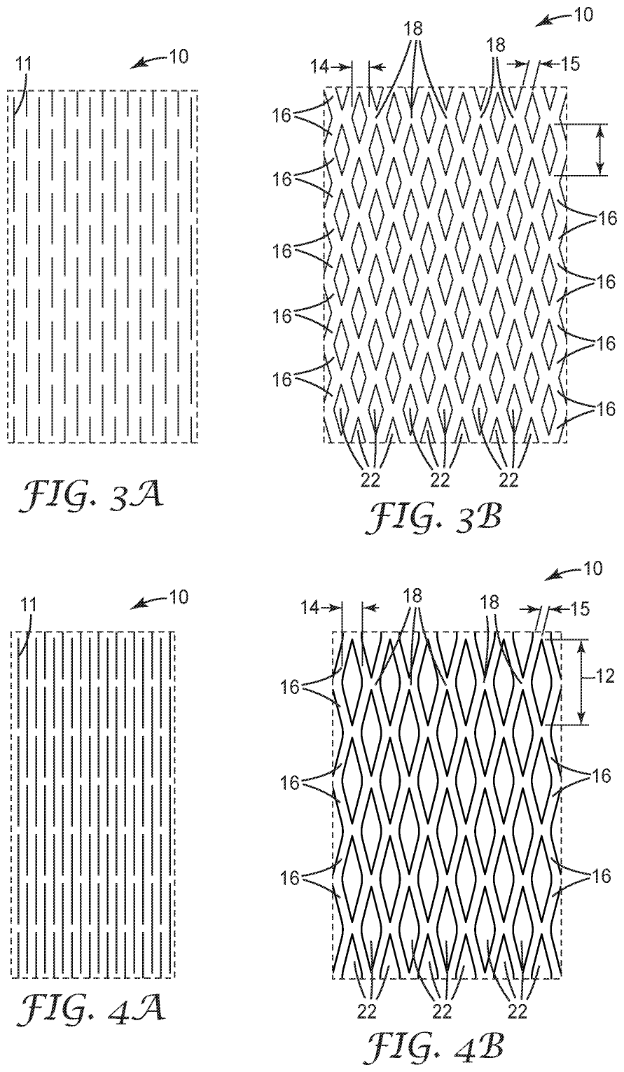

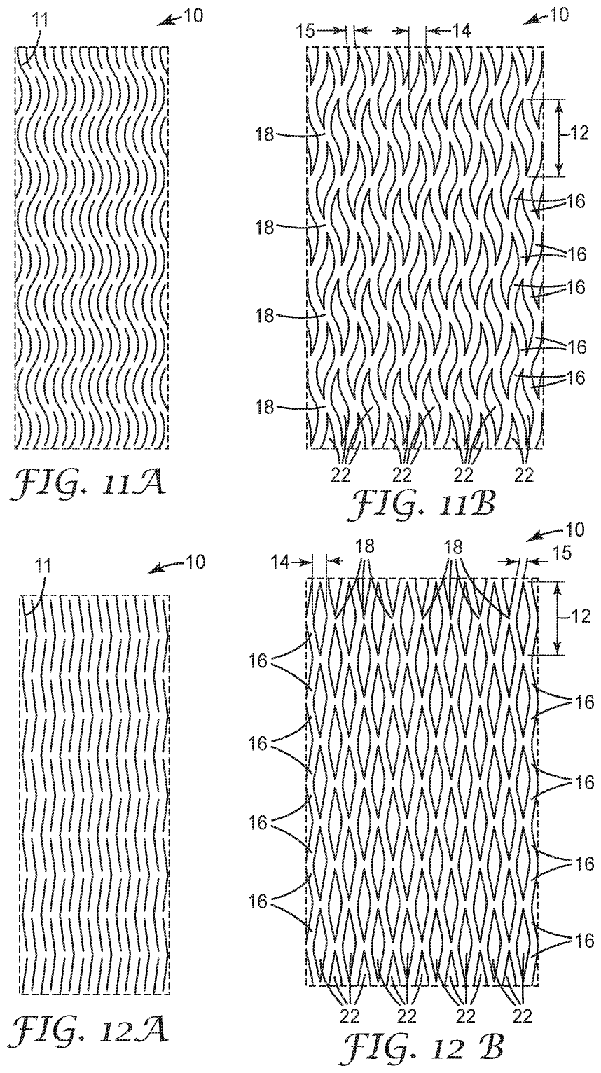

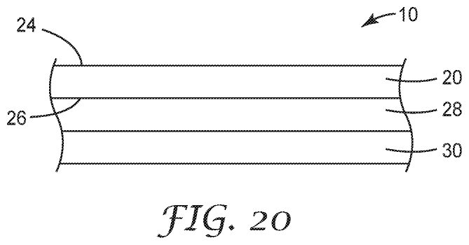

Referring to FIGS. 1A, 1B, 2A, 2B, 3A, 3B, 4A, 4B, 5A, 5B, 8A, 8B, 10A, 10B, 11A, 11B, 12A, 12B, 14A, 14B and 20, there is shown a reticulated reflective article 10 having a longitudinal direction and a width direction, and including a plurality of strands 16 of a reflective material 20 attached to one another at bridging regions 18 in the reflective material 20 and separable from one another between the bridging regions 18 to provide openings 22 in the reflective material, where the openings 22 provide a variably expandable area, and where the reflective material 20 comprises a reflective major surface 24 and a non-reflective major surface 26 (FIG. 20), also where each of the openings 22 has a longitudinal dimension 12, a width dimension 14, and each of the plurality of strands 16 has a thickness 15, and also where the reticulated reflective article 10 is expandable in at least one direction. In some embodiments, the direction of expansion is the longitudinal direction, such that expansion occurs along the axis parallel to the longitudinal dimension 12 of the reticulated reflective article 10. In some embodiments, the direction of expansion is the width direction such that expansion occurs along the axis parallel to the width dimension 14 of the reticulated reflective article 10.

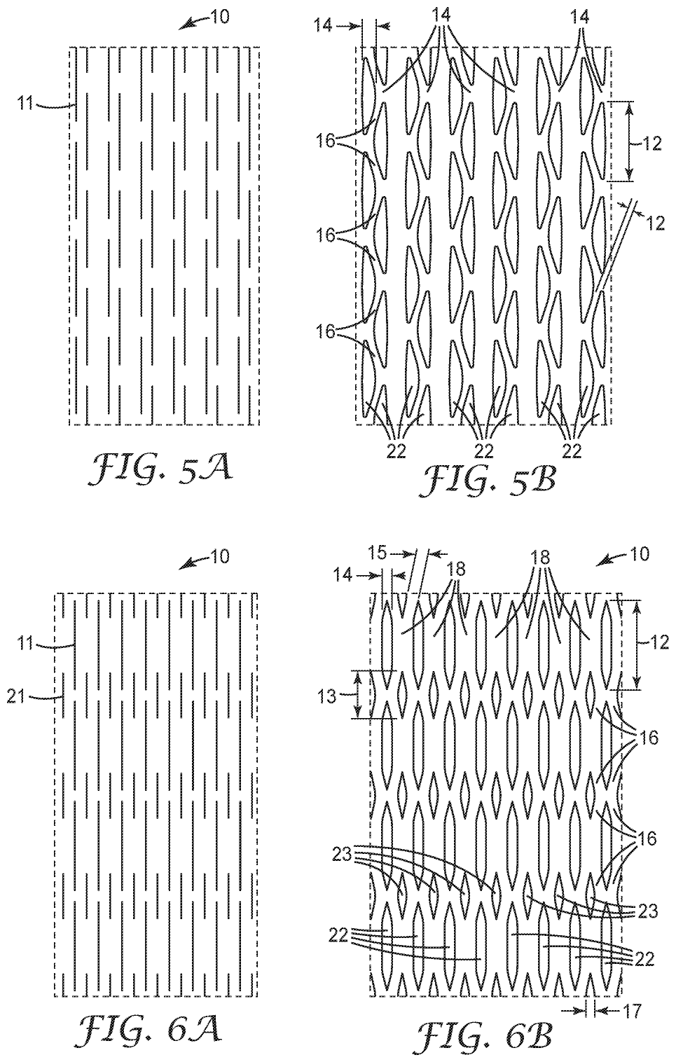

In some embodiments, the openings 22 are larger in the longitudinal direction 12 than in the width dimension. For example, in some embodiments, such as those depicted in FIGS. 1A, 1B, 2A, 2B, 3A, 3B, 4A, 4B, 12A, 12B, the openings 22 have a diamond shape. In some embodiments, such as those depicted in FIGS. 5A, 5B, 8A, 8B, 10A, 10B, 11A, 11B, 14A and 14B, the openings have a shape other than a diamond shape. As shown in FIGS. 1A, 2A, 3A, 4A, 4A, 5A, 8A, 10A, 11A and 12A, there is one sized slit 11 or perforation in the reticulated reflective article 10 that results in the openings 22 shown in FIGS. 1B, 2B, 3B, 4B, 5B, 8B, 10B, 11B, and 12B.

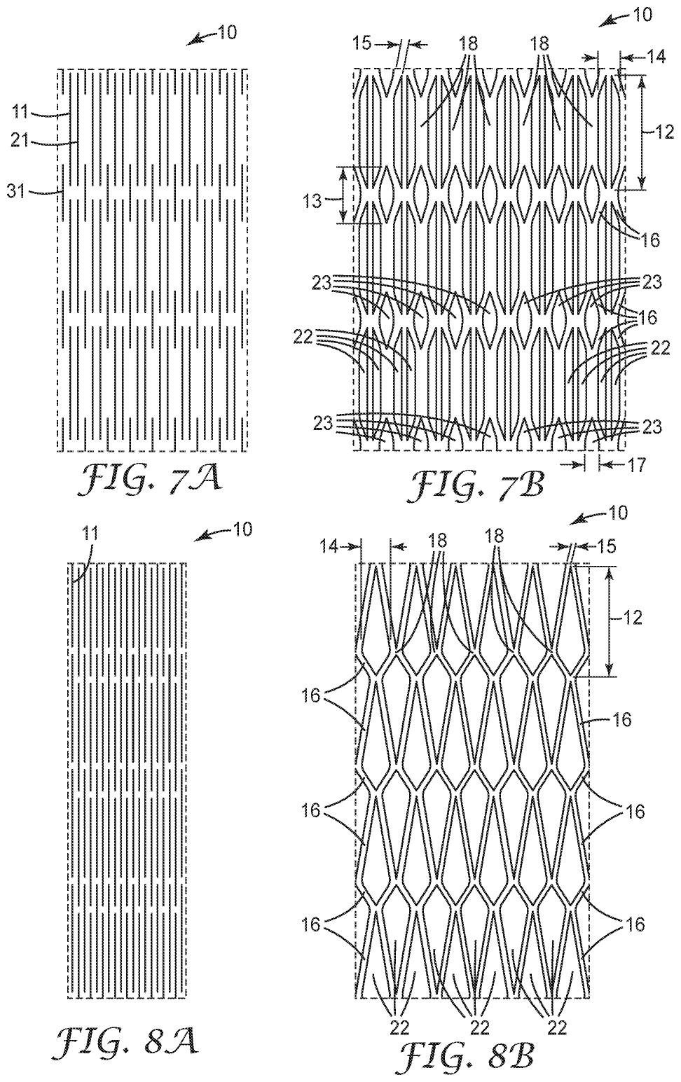

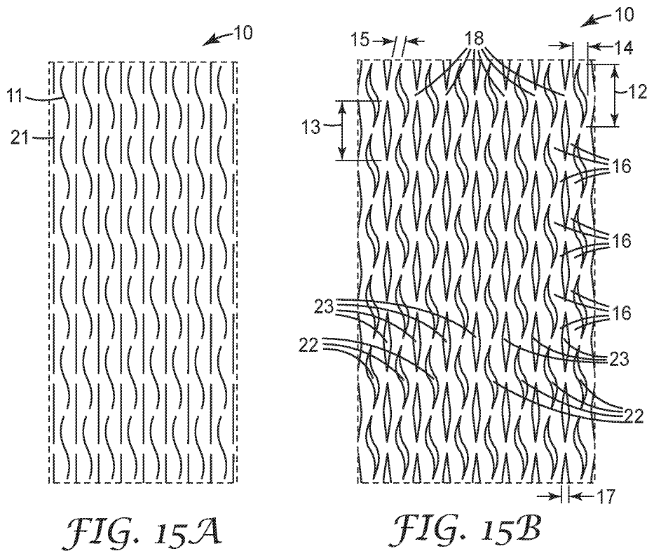

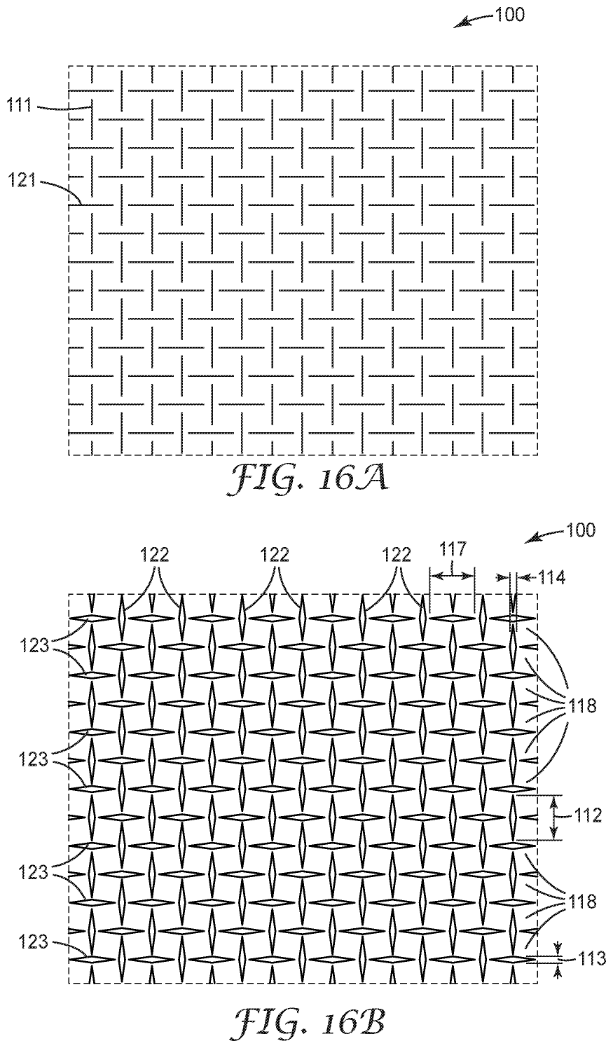

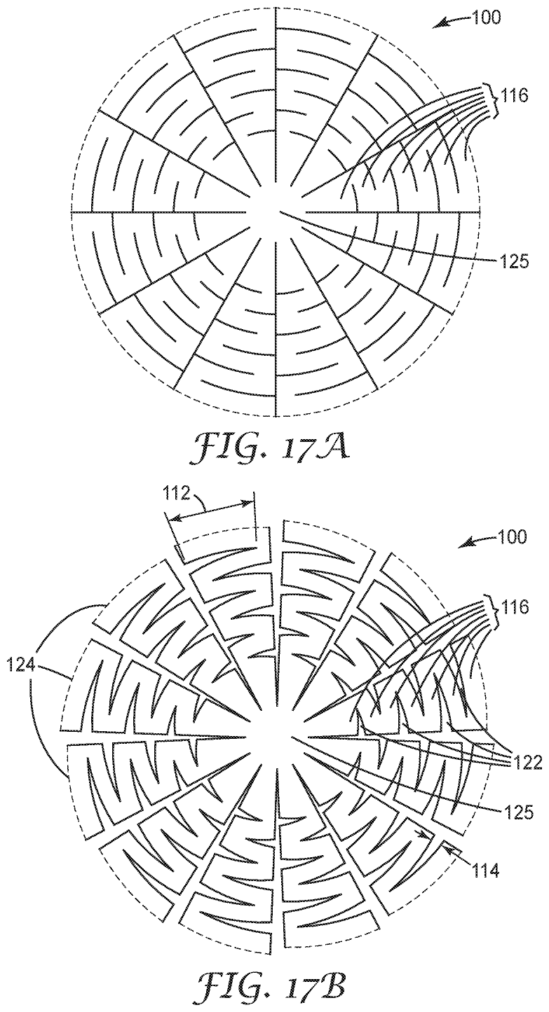

Referring now to FIGS. 6A, 6B, 14A, 14B, 15A and 15B, in some embodiments the presently disclosed reticulated reflective articles 10 provide two sets of openings for more complex expandability. For example, as shown in FIGS. 6A and 15A there are two sized slits 11, 21 or perforations in the reticulated reflective article 10 that result-in the openings 22, 23 shown in FIGS. 6B, 14B and 15B.

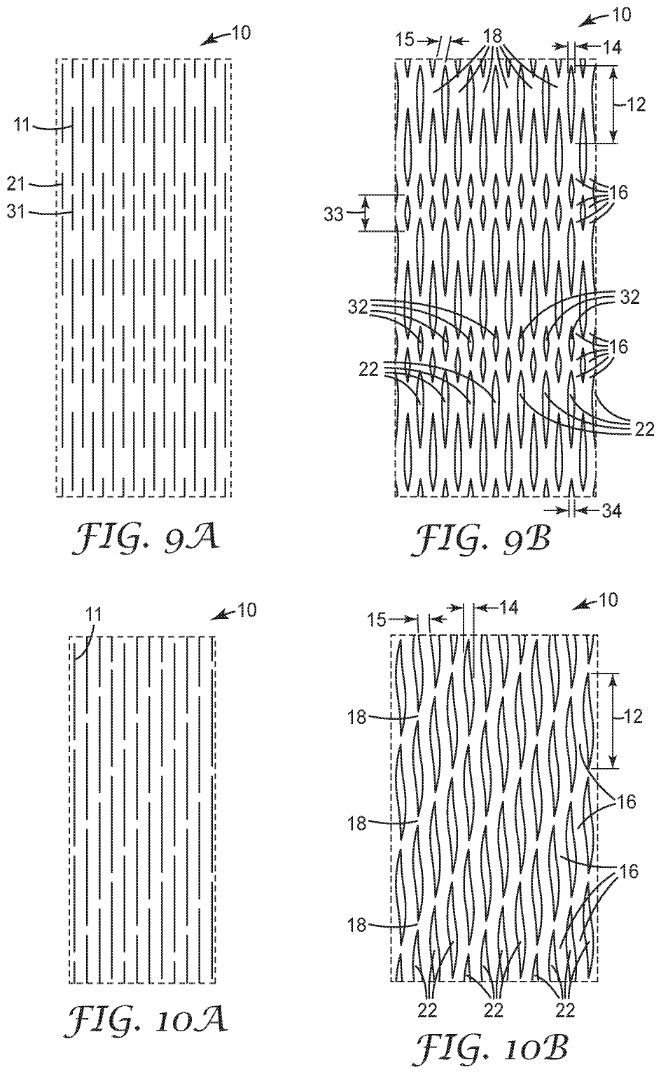

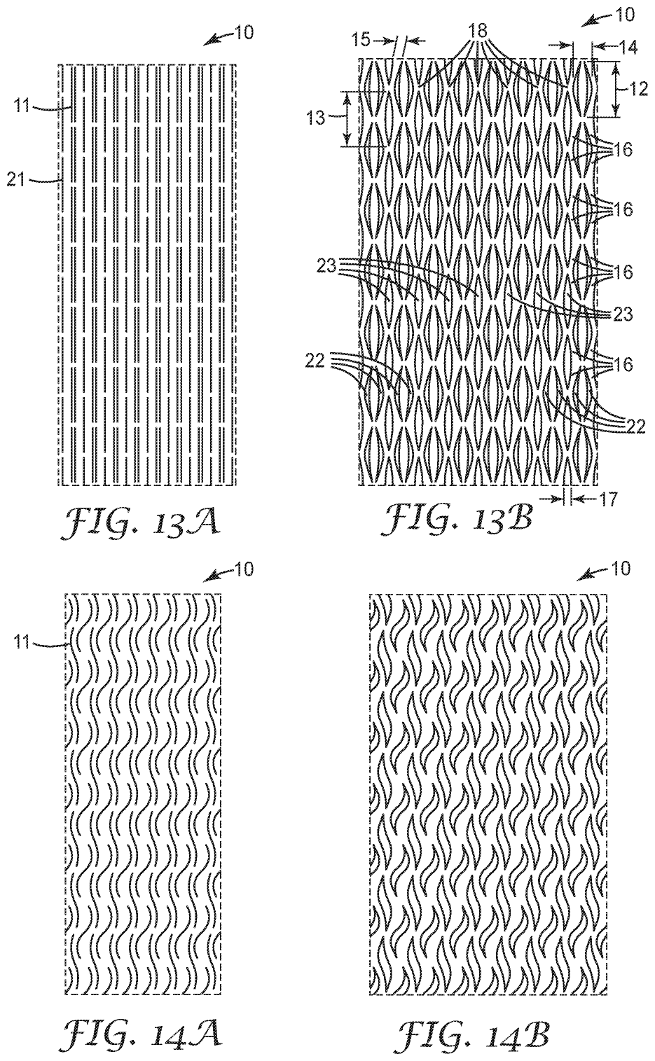

Referring now to FIGS. 7A, 7B, 9A, 9B, 13A and 13B, in some embodiments the presently disclosed reticulated reflective articles 10 provide more than two sets of openings for more complex expandability. For example, as shown in FIGS. 7A, 9A and 13A there are three sized slits 11, 21, 31 or perforations in the reticulated reflective article 10 that result-in the openings 22, 23 shown in FIGS. 7B, 9B and 13B.

In some embodiments, the reticulated reflective article 10 has a percent change in brightness depending on the amount of expansion of the reticulated reflective article 10. For example, as the reticulated reflective article 10 is expanded, brightness is decreased. In some embodiments, the reticulated reflective article 10 is expanded in area within a range of about 10% to at least about 300%. In some embodiments, the percent change in brightness from the non-expanded state of the reticulated reflective article 10 and an expanded version of the reticulated reflective article 10 is a percent reduction in brightness ranging from about 90% to even less than 40%. In some embodiments, the reticulated reflective article 10 provides a first reflective brightness when separated into a first width dimension between the plurality of strands 16 of reflective material 20 having an adhesive layer 28 (FIG. 20) disposed thereon and a second reflective brightness when separated into a second width dimension between the plurality of strands 16 of reflective material having an adhesive layer 28 disposed thereon. These varying brightnesses and permeabilities can be assessed before and/or after numerous washings of the reticulated reflective articles 10. In some embodiments, the change in open area from the first width dimension to the second width dimension is at least 20%, the reduction in brightness between the first reflective brightness and the second reflective brightness is from at least 25% reduction in brightness to about a 90% reduction in brightness, wherein both brightnesses are determined according to ASTM E810-03 (2013) when performed on unwashed reticulated reflective articles, and further wherein the reticulated reflective article has a permeability of at least 5.5 cm/s.

In some embodiments, first width dimension is less than the second width dimension. In some embodiments, the first reflective brightness is higher than the second reflective brightness. In some embodiments, non-reflective regions of the reticulated reflective article 10 comprise at least 25% of the total surface area of the reflective material 20. In some embodiments, non-reflective regions of the reticulated reflective article 10 comprise at least 50% of the total surface area of the reflective material 20.

In some embodiments, the reticulated reflective article 10 can be described by the relation of one slit to another slit at least before the article is stretched. In some embodiments, the reticulated reflective article 10 can be described by the relation of one slit to another slit before the article is stretched and after the article is stretched and it has returned, at least in part, to its pre-stretched state. If not specified, any degree of overlap or lack thereof is referring at least to the degree of overlap that is measured before a reticulated reflective article has been stretched, e.g., in a pre-stretched state. Specifically, the degree of overlap of slits that are offset with respect to an axis perpendicular to the longitudinal dimension 12 (or offset with respect to an axis perpendicular to the width dimension).

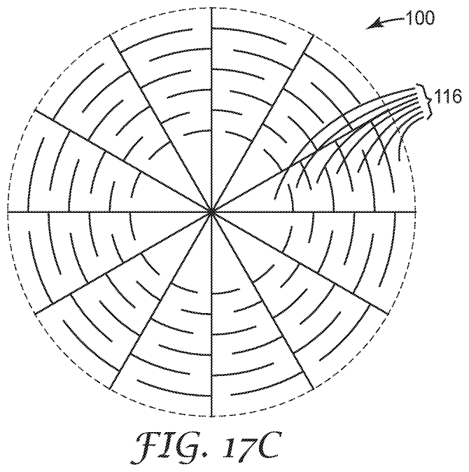

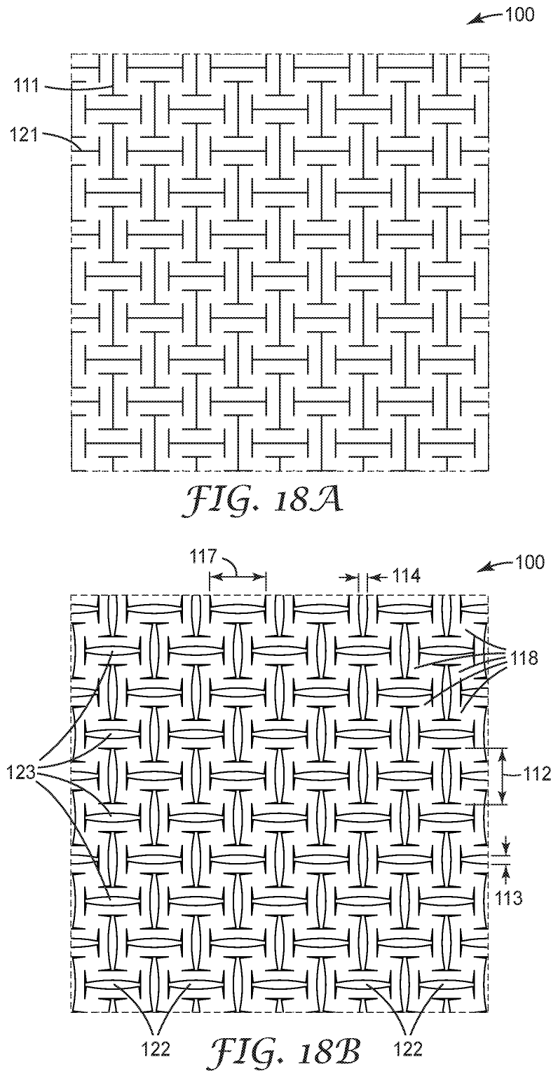

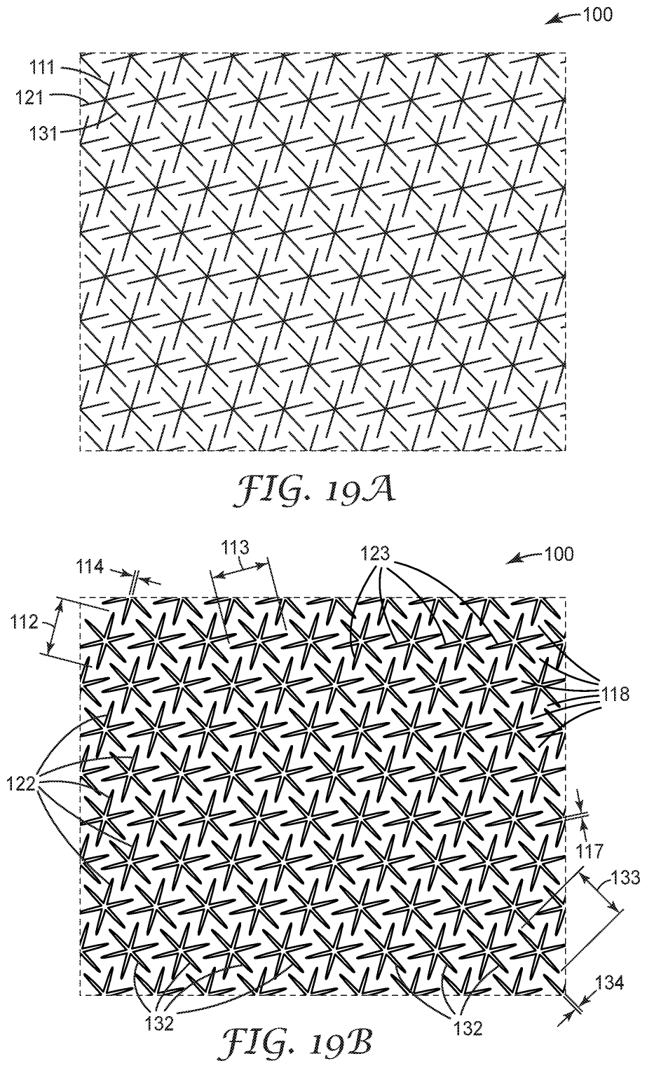

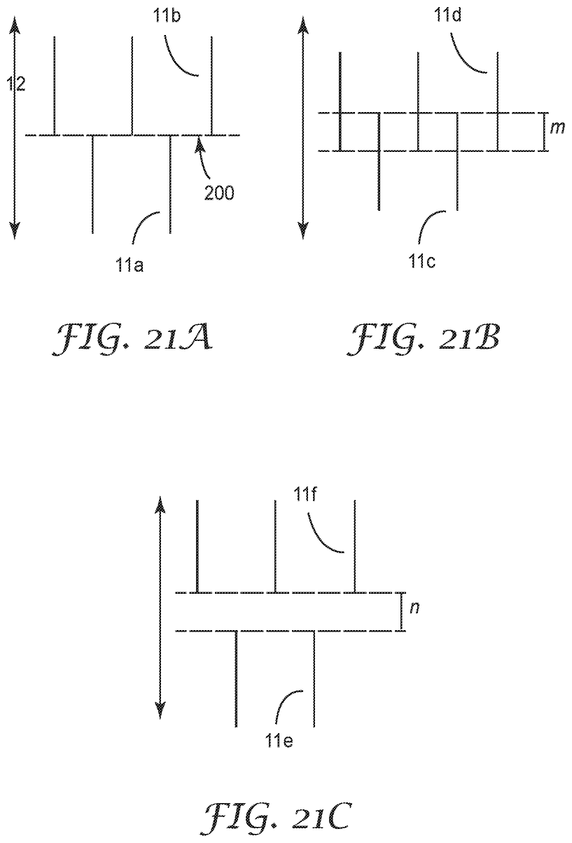

Adjacent slits can have negative overlap, no overlap (e.g., they are at substantially the same point) or some degree of overlap. FIGS. 21A, 21B and 21C illustrate the three conditions related to the degree of overlap. In FIGS. 21A, 21B and 21C, the degree of overlap is measured with respect to the longitudinal dimension, but one of skill in the art will understand that the degree of overlap could be measured with respect to the width dimension, or depending on the pattern (see for example FIGS. 16A, 16B, 17A, 17B, 18A, 18B, 19A and 19C) with respect to both the longitudinal and the width dimension. In summary, the degree of overlap can be measured by defining a mid-line, which is at least substantially perpendicular to the noted dimension (either longitudinal, width, or both independently) and relating the end points of adjacent slits to the mid line. Although only measurement with respect to the longitudinal dimension is illustrated herein, one of skill in the art, with the instant disclosure at hand would know how to measure the degree of overlap in the width dimension.

FIG. 21A schematically illustrates a reticulated reflective article 10 having slits 11a and 11b that are generally disposed parallel with the longitudinal dimension 12. A mid line 200 is an imaginary line substantially perpendicular or perpendicular (e.g., at a 90 degree angle with respect to) the longitudinal dimension 12. The mid line is defined as being located equidistance from opposite ends (e.g., a top end of a first and a bottom end of a second) of two adjacent slits 11a and 11b. In the embodiment depicted in FIG. 21A, the mid line 200 is equidistant from the top end of slit 11a and the bottom end of slit 11b. In this embodiment, the mid line 200 defines the top point of slit 11a and the bottom point of slit 11b (or vice versa). The slits in such an embodiment can be described as coming to the same line or coming to the mid line. Because of the repeating nature of the slits in many reticulated reflective articles, there are numerous mid lines that can be defined in any one article. In some embodiments, the dimensions obtained using any mid line will be substantially the same (within manufacturing tolerances) as any other mid line.

FIG. 21B schematically illustrates a reticulated reflective article 10 having slits 11c and 11d that are generally disposed parallel with the longitudinal dimension 12. In this embodiment, the two adjacent slits overlap in the longitudinal dimension, in that the top point of slit 11c is higher than the bottom point of slit 11d and therefore they overlap. The particular amount of overlap can be given by the dimension m. In the embodiment depicted in FIG. 21B, overlap, m, can be given as some amount. The dimension m is an absolute value and therefore it does not matter whether the distance is measured from the top of slit 11c or the bottom of slit 11d.

FIG. 21C schematically illustrates a reticulated reflective article 10 having slits 11e and 11f that are generally disposed parallel with the longitudinal dimension 12. As seen in FIG. 21C, there is no overlap of the top point of the bottom slit 11e and the bottom point of the top slit 11f. The distance they are apart in the longitudinal dimension can be given by the dimension, n. This type of configuration can be referred to as negative overlap. In slit patterns where the negative overlap is large, e.g., where the top and bottom points of adjacent slits are too far away, relatively speaking, the reticulated retroreflective pattern will not expand or will not expand as much as desired when stretched. A reticulated retroreflective pattern that does not expand or does not expand to the desired amount may not include the same advantages as one that will expand a desired amount, e.g., it may not provide better retroreflective properties over a larger area for the same cost, it may not provide comparable or better retroreflective properties over the same are for less cost, it may not provide a desired permeability or airflow, or some combination thereof.

In some embodiments, a reticulated retroreflective article can include a slit pattern having a dimension, n, that is not greater than 40 mm. Or stated another way, top and bottom points of any two adjacent (offset in an axis perpendicular to the longitudinal dimension) slits are not greater than 40 mm away from each other, as defined above. In some embodiments, a reticulated retroreflective article can include a slit pattern having a dimension, n, that is not greater than 25 mm. Or stated another way, top and bottom points of any two adjacent (offset in an axis perpendicular to the longitudinal dimension) slits are not greater than 25 mm from each other. In some embodiments, a reticulated retroreflective article can include a slit pattern having a dimension, n, that is not greater than 15 mm. Or stated another way, top and bottom points of any two adjacent (offset in an axis perpendicular to the longitudinal dimension) slits are not greater than 15 mm away from each other. In some embodiments, a reticulated retroreflective article can include a slit where the top and bottom points of adjacent slits can be 0 mm (or within manufacturing tolerances away) from the mid line, as defined above.

Referring now to FIG. 20, a carrier tape (not shown) can be adhered to the reflective major surface 24 of the reflective material 20 along the reflective major surface 24. In some embodiments, the reticulated reflective article 10 further comprises an adhesive layer 28 disposed on one of the major surfaces of the reflective material 20, where the adhesive layer 28 is separable into a plurality of strands disposed on the plurality of strands 16 of the reflective material 20. The reticulated reflective article 10 may also be adhered to a substrate 30 disposed on a major surface of the adhesive layer 28 opposite the reflective material 20. In some embodiments, the substrate is elastomeric.

The presently disclosed reticulated reflective articles 10 have a first brightness when in a non-expanded form and a second brightness when in an expanded form. The presently disclosed reticulated reflective articles 10 have a first permeability when in a non-expanded form and a second permeability when in an expanded form. The presently disclosed reflective material 20 is selected from at least one of optical films, microprismatic film and microsphere films.

Referring now to FIGS. 16A, 16B, 17A, 17B, 18A, 18B, 19A, 19B and 20, in some embodiments, the reticulated reflective articles 100 are expandable in more than one direction. In some embodiments, the reticulated reflective articles 100, have a longitudinal direction and a width direction, and have a plurality of regions 116 of a reflective material 20 separable from one another to provide openings 122 in the reflective material 20, wherein the reflective material 20 comprises a reflective major surface 24 and a non-reflective major surface 26, wherein each of the openings 122 has a longitudinal dimension 112, and a width dimension 114, and wherein the reticulated reflective article 100 is expandable in at least two directions.

In some embodiments, the presently disclosed article 100 also includes a multitude 124 of the plurality of regions 116 extending radially from a common intersection 125. In some embodiments, the presently disclosed articles 100 provide a first reflective brightness when separated into a first width dimension between the plurality of regions 116 of reflective material 20 and a second reflective brightness when separated into a second width dimension between the plurality of regions 116 of reflective material 20.

In some embodiments, the reticulated reflective article 100 has a percent change in brightness depending on the amount of expansion of the reticulated reflective article 100. For example, as the reticulated reflective article 100 is expanded, brightness is decreased. In some embodiments, the reticulated reflective article 100 is expanded in area within a range of about 10% to at least about 300%. In some embodiments, the percent change in brightness from the non-expanded state of the reticulated reflective article 100 and an expanded version of the reticulated reflective article 100 is a percent reduction in brightness ranging from about 90% to even less than 40%. In some embodiments, the reticulated reflective article 100 provides a first reflective brightness when separated into a first width dimension between the plurality of regions 116 of reflective material 20 having an adhesive layer 28 disposed thereon and a second reflective brightness when separated into a second width dimension between the plurality of regions 116 of reflective material having an adhesive layer 28 disposed thereon. These varying brightnesses and permeabilities can be assessed before and/or after numerous washings of the reticulated reflective articles 100. In some embodiments, the change in open area from the first width dimension to the second width dimension is at least 20%, the reduction in brightness between the first reflective brightness and the second reflective brightness is from at least 25% reduction in brightness to about a 90% reduction in brightness, wherein both brightnesses are determined according to ASTM E810-03 (2013) when performed on unwashed reticulated reflective articles, and further wherein the reticulated reflective article has a permeability of at least 5.5 cm/s.

In some embodiments, the presently disclosed reticulated reflective articles 100 provide a first reflective brightness when separated into a first width dimension between the plurality of regions 116 of reflective material 20 having an adhesive layer 28 disposed thereon and a second reflective brightness when separated into a second width dimension between the plurality of regions 116 of reflective material 20 having an adhesive layer 28 disposed thereon. In some embodiments, the first reflective brightness is higher than the second reflective brightness.

Referring again to FIG. 20, the presently disclosed reticulated reflective article 100 also includes a carrier tape (not shown) adhered to the reflective major surface 24 of the reflective material 20. In some embodiments, the presently disclosed reticulated reflective article 100 provides an adhesive layer 28 disposed on one of the major surfaces of the reflective material 20, wherein the adhesive layer 28 is separable into a plurality of regions disposed on the plurality of regions 116 of the reflective material 20. In some embodiments, the presently disclosed reticulated reflective article 100 includes a substrate 30 disposed on a major surface of the adhesive layer 28 opposite the reticulated reflective material 20. In some embodiments, the substrate is elastomeric.

In some embodiments, the presently disclosed reticulated reflective articles 100 have a first brightness when in a non-expanded form and a second brightness when in an expanded form. In some embodiments, the presently disclosed reticulated reflective articles 100 have a first permeability when in a non-expanded form and a second permeability when in an expanded form. These varying brightnesses and permeabilities can be assessed after numerous washings of the reticulated reflective articles 100. In some embodiments, the useful reflective material 20 is selected from at least one of optical films, microprismatic film and microsphere films.

In some embodiments, the slits 11, 21, 31, perforations, or combinations thereof can be made using any known techniques, such as rotary die cutting, laser cutting, ultrasonic slitting, and the like.

The retroreflective articles of this disclosure can be incorporated into a wide variety of commercial articles to impart retroreflectivity to the commercial articles. Examples of suitable commercial articles include: display articles such as signs, billboards, pavement markings, and the like; transportation articles such as bicycles, motorcycles, trains, buses, and the like; and clothing articles such as shirts, sweaters, sweatshirts, jackets, coats, pants, shoes, socks, gloves, belts, hats, suits, one-piece body garments, vests, bags, and backpacks, and the like. Additional articles on which the presently disclosed reflective articles can be used include articles useful for camping gear, baby gear, pet accessories, toys, phone accessories, sport accessories, fashion accessories, and the like. The presently disclosed reflective articles can also be converted into logos, designs such as outlines, patterns, silhouettes, shapes, lines, patches, panels, notions (as example: piping, tape, buttons, binding, zippers, trim, lace) and the like.

Firefighter garments, and thus multi-layer firefighter outfits, can be greatly improved by implementing vapor permeable reflective material. If vapor cannot escape thought the outer shell because conventional reflective material provides a vapor barrier, hot vapors can be directed inward, toward the skin of the wearer, possibly causing steam burns or other discomfort to the wearer. The techniques described herein resolve this issue by providing a reflective material formed in a reticulated pattern to define reflective regions and non-reflective regions. In this manner, the addition of reflective material does not substantially decrease vapor permeability of the outer shell.

Thermal decay through an outer shell having conventional reflective trim material, such as perforated reflective trim material, is substantially less than thermal decay through the outer shell in regions not having the conventional reflective trim material. Thus, heat trapped within the protective garment may not be able to escape fast enough for the firefighter to cool off at a desired rate. Rather, the presence of conventional reflective material such as perforated reflective trim material can cause heat to remain trapped inside the protective garment for longer periods of time, providing discomfort to the firefighter even after he or she has left the fire. The techniques described herein resolve this issue by providing a non-continuous vapor permeable reflective material that does not substantially decrease thermal decay of the garment in the portions having the non-continuous vapor permeable reflective material. In this manner, the vapor permeable reflective material can reduce the heat load within the various layers that comprise the firefighter outfit, reduce negative physiological impacts on the wearer, and reduce the likelihood of producing burn injuries on the wearer.

The techniques described herein can provide reticulated vapor permeable reflective material having a reflective brightness greater than about 25 candelas/(lux*meter²) or even greater than 250 candelas/(lux*meter²). Brightnesses in these ranges significantly increase visibility of a wearer during nighttime and twilight hours. Indeed, this can better ensure that firefighters are not only seen by night motorists, but more importantly, these brightness ranges can be achieved while still providing the vapor permeability and thermal decay characteristics described above.

Following is a non-limiting disclosure of embodiments and combinations of embodiments of the presently disclosed reticulated reflective articles:

### Embodiment 1

A reticulated reflective article, comprising:
a plurality of strands of a reflective material attached to one another at bridging regions in the reflective material and separable from one another between the bridging regions to provide openings in the reflective material, wherein the openings are expandable to provide a variably expandable area, and
wherein the reflective materials comprises a reflective major surface and a non-reflective major surface, wherein each of the openings has a longitudinal dimension, a width dimension, and each of the plurality of strands has a thickness, and
wherein the reticulated reflective article is expandable in at least both of a longitudinal direction and a width direction.

### Embodiment 2

The article of Embodiment 1, wherein the article provides a first reflective brightness when separated into a first width dimension between the plurality of strands of reflective material and a second reflective brightness when separated into a second width dimension between the plurality of strands of reflective material.

### Embodiment 3

The article of Embodiment 2, wherein the reduction in brightness between the first reflective brightness and the second reflective brightness is from at least about 10% reduction in brightness to about a 90% reduction in brightness, wherein both brightnesses are determined according to ASTM E810-03 (2013) when performed on unwashed reticulated reflective articles.

### Embodiment 4

The article of Embodiment 2, wherein the change in open area from the first width dimension to the second width dimension is at least 20%, the reduction in brightness between the first reflective brightness and the second reflective brightness is from at least 25% reduction in brightness to about a 90% reduction in brightness, wherein both brightnesses are determined according to ASTM E810-03 (2013) when performed on unwashed reticulated reflective articles, and further wherein the reticulated reflective article has a permeability of at least 4.5 cm/s.

### Embodiment 5

The article of Embodiment 2, wherein the article provides a first reflective brightness when separated into a first width dimension between the plurality of strands of reflective material having an adhesive layer disposed thereon and a second reflective brightness when separated into a second width dimension between the plurality of strands of reflective material having an adhesive layer disposed thereon.

### Embodiment 6

The article of Embodiments 3 and 4, wherein the first width dimension is less than the second width dimension.

### Embodiment 7

The article of Embodiment 6, wherein the first reflective brightness is higher than the second reflective brightness.

### Embodiment 8

The article of Embodiment 1, wherein non-reflective regions comprise at least 25% of the total surface area of the reflective material.

### Embodiment 9

The article of Embodiment 1, wherein non-reflective regions comprise at least 50% of the total surface area of the reflective material.

### Embodiment 10

The article of Embodiment 1, further comprising a carrier tape adhered to the reflective major surface of the reflective material.

### Embodiment 11

The article of Embodiment 1 further comprising an adhesive layer disposed on one of the major surfaces of the reflective material, wherein the adhesive layer is separable into a plurality of strands disposed on the plurality of strands of the reflective material.

### Embodiment 12

The article of Embodiment 2, further comprising a substrate disposed on a major surface of the adhesive layer opposite the reticulated reflective article.

### Embodiment 13

The article of Embodiment 12, wherein the substrate is elastomeric.

### Embodiment 14

The article of Embodiment 12, wherein the article has a first brightness when it is in a non-expanded form and a second brightness when it is in an expanded form.

### Embodiment 15

The article of Embodiment 12, wherein the article has a first permeability when it is in a non-expanded form and a second permeability when it is in an expanded form.

### Embodiment 16

The article of any of the preceding Embodiments, wherein the reflective material is selected from at least one of optical films, microprismatic film and microsphere films.

### Embodiment 17

A reticulated reflective article, having a longitudinal direction and a width direction, and comprises:
a plurality of regions of a reflective material separable from one another to provide openings in the reflective material, wherein the reflective materials comprises a reflective major surface and a non-reflective major surface,
wherein each of the openings has a longitudinal dimension, and a width dimension, and
wherein the reticulated reflective article is expandable in at least two directions.

### Embodiment 18

The article of Embodiment 17 further comprising a multitude of the plurality of regions extending radially from a common intersection.

### Embodiment 19

The article of Embodiments 17 or 18, wherein the article provides a first reflective brightness when separated into a first width dimension between the plurality of regions of reflective material and a second reflective brightness when separated into a second width dimension between the plurality of regions of reflective material.

### Embodiment 20

The article of Embodiment 19, wherein the reduction in brightness between the first reflective brightness and the second reflective brightness is from about 10% reduction in brightness to about a 90% reduction in brightness, wherein both brightnesses are determined according to ASTM E810-03 (2013) when performed on unwashed reticulated reflective articles.

### Embodiment 21

The article of Embodiment 19, wherein the change in open area from the first width dimension to the second width dimension is at least 20%, the reduction in brightness between the first reflective brightness and the second reflective brightness is from at least 25% reduction in brightness to about a 90% reduction in brightness, wherein both brightnesses are determined according to ASTM E810-03 (2013) when performed on unwashed reticulated reflective articles, and further wherein the reticulated reflective article has a permeability of at least 4.5 cm/s, or in some embodiments, at least 4.8 cm/s.

### Embodiment 22

The article of Embodiment 19, wherein the article provides a first reflective brightness when separated into a first width dimension between the plurality of regions of reflective material having an adhesive layer disposed thereon and a second reflective brightness when separated into a second width dimension between the plurality of regions of reflective material having an adhesive layer disposed thereon.

### Embodiment 23

The article of Embodiment 21, wherein the first reflective brightness is higher than the second reflective brightness.

### Embodiment 24

The article of Embodiment 17, further comprising a carrier tape adhered to the reflective major surface of the reflective material.

### Embodiment 25

The article of Embodiment 17 further comprising an adhesive layer disposed on one of the major surfaces of the reflective material, wherein the adhesive layer is separable into a plurality of regions disposed on the plurality of regions of the reflective material.

### Embodiment 26

The article of Embodiment 19, further comprising a substrate disposed on a major surface of the adhesive layer opposite the reticulated reflective article.

### Embodiment 27

The article of Embodiment 17, wherein the substrate is elastomeric.

### Embodiment 28

The article of Embodiment 25, wherein the article has a first brightness when it is in a non-expanded form and a second brightness when it is in an expanded form.

### Embodiment 29

The article of Embodiment 25, wherein the article has a first permeability when it is in a non-expanded form and a second permeability when it is in an expanded form.

### Embodiment 30

The article of any of Embodiments 17 to 29, wherein the reflective material is selected from at least one of optical films, microprismatic film and microsphere films.

### Embodiment 31

A reflective article having at least a longitudinal dimension and a width dimension, the article comprising:

a reflective layer comprising optical film, microprismatic film, microsphere film, or combinations thereof having a plurality of slits formed therein, the plurality of slits having a slit direction and each slit having a top and an opposing bottom direction along the slit direction, the slit direction being at least substantially parallel to the longitudinal dimension or the width dimension, the plurality of slits comprising at least two adjacent slits offset with respect to an axis perpendicular to the slit direction, wherein the top of and bottom of at least two adjacent slits are not greater than 40 mm apart along the slit direction when the reflective article is in a pre-stretched condition.

This invention is illustrated by the following examples, but the particular materials and amounts thereof recited in these examples, as well as other conditions and details should not be construed to unduly limit this disclosure.

### Test Methods

### Test Method for Measuring Retroreflectivity of Materials

Retroreflectivity for the examples was measured using the test criteria described in ASTM E810-03 (2013)—Standard Test Method for Coefficient of Retroreflection of Retroreflective Sheeting Utilizing the Coplanar Geometry. Results, measured as retroreflective units Rₐ, which represents the units of cd/lux/m².

### Test Method for Determining Open Area

The % open area for each of the expanded/reticulated films was determined mathematically by dividing amount of expansion by final width of the expanded/reticulated films.

### Test Method for Measuring Wash Durability

Wash durability was measured following ISO 6330 Method 2A (60 C home wash). Retroreflectivity was measured before washing, and after 75 wash cycles. Results, measured as reflective units Rₐ, which represents the units of cd/lux/m².

### Test Method for Measuring Air Permeability

Air permeability was measured following ASTM D737-04 (2016)—Standard Test Method for Air Permeability of Textile Fabrics. Results are reported as cm/s (cfm/sq ft).

### Methods for Preparing Slit and Expanded/Reticulated Reflective Films

Slit reflective film can be prepared any of a number of ways, including rotary die cutting and laser cutting. The slit films described in the Examples below were made by rotary die cutting 5 cm (2 inch) wide reflective material available under the trade designation “3M Scotchlite 8725 Silver Transfer Film” from 3M Company, St. Paul, Minn. Openings were cut in the transfer film with a straight opening shape, a 22 mm longitudinal repeat with one opening per repeat in the longitudinal direction and 2 openings per width repeat.

Alternatively, reflective material commercially available under the trade designation “3M Scotchlite 8725 Silver Transfer Film” can be slit via laser cutting system, using a laser cutter commercially available under the trade designation “Mini FlexPro Model LB2440” from Preco Incorporated, Lenexa, Kans., with a 400 watt CO2, 9.36 nm wavelength resonator. Power settings were 40 to 60% in pulsed mode. The laser ablated an array of slits approx. 200 microns wide.

The expanded/reticulated films described in the Examples below were made using a manual expanding/spreading process to expand the die cut or laser cut films. Alternatively, expanded/reticulated films may be made via an automated process using a nip roll equipped with a spreader bar. The extent of spreading is controlled by the deflection of the spreader bar against the slit film, the degree of curvature of the spreader, and the tension of slit film. The spread/reticulated film material is then passed over a high traction nip roll where the spread/reticulated configuration is held, and then the film is laminated to a release liner (such as that commercially available under trade designation “8403” from 3M Company, St. Paul. Minn.) and wound onto a 7.6 cm (3 inch) cardboard core. The films are not limited to expansion in longitudinal or width directions only, and in certain configurations can be expanded radially or multi-directionally.

FIGS. 1 to 15 represent a range of slit film patterns, with the “A” figures showing the film in slit and unexpanded/unreticulated state, and with the “B” figures showing the same film patterns in an expanded/reticulated state.

### EXAMPLES

### Example 1

Example 1 describes a slit film without expansion/reticulation, produced by laminating a manually assembled retroreflective film to a woven fabric or substrate with an adhesive layer. The slit reflective film was made by rotary die cutting 5 cm (2 inch) wide reflective film, commercially available under the trade designation “3M Scotchlite 8725 Silver Transfer Film” from 3M Company, St. Paul, Minn. Openings were cut in the transfer film with a straight opening shape, a 22 mm longitudinal repeat with one opening per repeat in the longitudinal direction and 2 openings per width repeat. Openings were separated by strand width of 2 mm/2 mm. The bridge regions longitudinal directions were 2 mm/2 mm with the bridge regions offset 0%/50%. After slitting lined products, the paper liner was removed (manually or with a winder roll to strip the liner) and replaced with a release liner commercially available under the trade designation “3M Polyester 8403” from 3M Company on the beaded side. The slit film was then heat laminated to a twill weave polyester fabric such as that commercially available under the trade designation “Lauffenmüle fabric (#42040, 65% polyester/35% cotton, 215 g/m2, color: Bugatti Royal #40228/2)” from Lauffenmüle Textil GmbH, Lauchingen, Germany. Lamination was done using a transfer press such as that commercially available under the trade designation “Stahls' Hotronix Thermal Transfer Press STX20” from Stahls' Hotronix, Carmichaels, Pa. at 177 C (350 F) for a dwell time of 20 seconds at an airline pressure setting of 4.

After the sample cooled to room temperature, the release liner was removed, yielding a reticulated retroreflective article.

The reticulated and fabric laminated samples were tested according to Test Method for Measuring Wash Durability and Test Method for Measuring Air Permeability, described above, with values for Brightness (Rₐ) and Permeability given in Table 1.

Values of opening shape, repeat longitudinal direction [mm], number of openings longitudinal repeat, number of openings width repeat, strand width [mm], bridge regions longitudinal direction [mm], bridge region offset [%], and variation from standard are given in Tables 2 and 3. Example 1 corresponds to FIG. 4 in Table 2.

### Example 2

Example 2 was prepared by slitting the film as in Example 1, and then expanding/reticulating to approximately 24% open area. The slit film of Example 1 was manually expanded by placing the slit film with bead side up and securing the ends of the film to a flat surface with masking tape, such as that commercially available under the trade designation “3M Industrial Masking Tape” from 3M Company, to keep the slit film flat and straight. The bottom edge of the film was secured to a flat surface placing the tape parallel to the slit openings at a desired film edge width. A rigid low profile flat spreader bar (e.g. ruler), used to spread the film, was secured to the top of the slit film. Short edges were trimmed. The spreader bar was pulled in a direction perpendicular in the plane to the slit direction, to expand the film to the desired spread distance.

The expanded film was secured along the top of the spreader bar edge with masking tape. A release liner, such as that commercially available under the trade designation “3M Polyester Tape 8403” from 3M Company, was then applied to the top (bead side) of the film and rolled down flat with a rubber roller to adhere the expanded configuration to the transfer film. The expanded reticulated film material was then heat laminated as in Example 1.

After the sample cooled to room temperature, the release liner was removed, yielding a reticulated expanded reflective article. The sample was thereafter laminated and tested as Example 1.

### Example 3

Example 3 was prepared by slitting the film as in Example 1, and then expanding/reticulating as in Example 2, to an open area of approximately 60% followed by laminating and testing as Example 1.

### Example 4

Example 4 was prepared by slitting the 3M™ SCOTCHLITE™ Reflective Material—C790 Carbon Black Stretch Transfer Film from 3M Company as in Example 1, and then expanding/reticulating as in Example 2 and followed by laminating and testing as in Example 1.

### Comparative Example C1

Comparative Example C1 consists of 5 cm (2 inch) wide transfer film, such as that commercially available under the trade designation “3M Scotchlite 8725 Silver Transfer Film” from 3M Company, laminated and tested as described in Example 1 except that no carrier tape was present.

### Comparative Example C2

Comparative Example C2 consists of 5 cm (2 inch) wide reflective material, such as that commercially available under the trade designation “3M Scotchlite Reflective Material 5510 Segmented Home Wash Trim” from 3M Company, laminated and tested as Example 1. Comparative Example 2 is created using a technique different than the technique used for Examples 1 to 3 because for Comparative Example 2 is created by using a continuous sheet of the reflective material, cutting out portions and then removing them. It is not an expandable reflective material.

### Comparative Example C3

Comparative Example C3 consists of 5 cm (2 inch) wide transfer film, such as that commercially available under the trade designation “3M™ Scotchlite™ Reflective Material—C790 Carbon Black Stretch Transfer Film” from 3M Company, laminated and tested as described in Example 1 except that no carrier tape was present.

TABLE 1

| | | | | | Brightness | Permeability |
|---|---|---|---|---|---|---|
| | | Open area | Waste | Brightness | reduction | [cm/s] |
| Example | Sample | [%] | [%] | [Rₐ] | [%] | (cfm/sq ft) |
| 1 | 8725 | 0 | 0 | 468 | 0 | less than 1.7 |
| | 20 mm | | | | | (less than 3.3) |
| 2 | 8725 | 24 | 0 | 341 | 27 | 5.8 |
| | 20 mm | | | | | (11.5) |
| 3 | 8725 | 60 | 0 | 177 | 62 | 11.9 |
| | 20 mm | | | | | (23.4) |
| 4 | C790 | 24 | 0 | 156 | 46 | 4.8 |
| | 20 mm | | | | | (9.5) |
| C1 | 8725 | 0 | 0 | 497 | 0 | less than 1.7 |
| | control | | | | | (less than 3.3) |
| C2 | 5510 | 24 | 24 | 369 | 26 | 2.9 |
| | control | | | | | (5.7) |
| C3 | C790 | 0 | 0 | 291 | 0 | less than 1.7 |
| | control | | | | | (less than 3.3) |

TABLE 2

| | | | | | | Bridge | | | |
|---|---|---|---|---|---|---|---|---|---|
| | | Repeat | Number of | Number of | | regions | Bridge | | |
| | | longitudinal | openings | openings | Strand | longitudinal | region | Variation | |
| FIG. | Opening | direction | longitudinal | width | width | direction | offset | from | Method of |
| Number | shape | [mm] | repeat | repeat | [mm] | [mm] | [%] | standard | making |
| 1 | straight | 8 | 1 | 2 | 1/1 | 1/1 | 0/50 | standard | laser |
| 2 | straight | 9 | 1 | 2 | 1/1 | 2/2 | 0/50 | bridge | laser |
| 3 | straight | 9 | 1 | 2 | 2/2 | 2/2 | 0/50 | strand | laser |
| 4 | straight | 22 | 1 | 2 | 2/2 | 2/2 | 0/50 | repeat length | rotary die |
| 5 | straight | 9 | 1 | 2 | 2/1 | 2/2 | 0/50 | multiple strand | laser |
| | | | | | | | | widths | |
| 6 | straight | 17 | 1 | 2 | 2/2 | 2/10 | 0/50 | multiple bridge | laser |
| | | | | | | | | lengths | |
| 7 | straight | 17 | 1 | 3 | 1/1/1 | 2/2/10 | 0/0/50 | >2 CD repeat | laser |
| 8 | straight | 45 | 1 | 2 | 2/2 | 2/2 | 0/25 | offset | laser |
| 9 | straight | 30 | 2 | 2 | 2/2 | 1.7/6.2 | 0/50/30 | 2 slit lengths | laser |
| | | | | | | | | MD repeat | |
| 10 | straight | 17 | 1 | 4 | 2/2/2/2 | 2/2/2/2 | 0/25/50/75 | combo >2 | laser |
| | | | | | | | | bridge offset | |
| 11 | s-curve | 19 | 1 | 2 | 2/2 | 2/2 | 0/50 | different shape | laser |
| 12 | arrow | 17 | 1 | 2 | 2/2 | 2/2 | 0/50 | different shape | laser |
| 13 | straight/ | 17 | 1 | 3 | 2/2/2 | 2/2/2 | 0/50/50 | combo 3 lines | laser |
| | curve/ | | | | | | | | |
| | curve | | | | | | | | |
| 14 | s-curve1/ | 13 | 1 | 2 | 2/2 | 2/2 | 0/50 | combo 2 curves | laser |
| | s-curve2 | | | | | | | in same pattern | |
| 15 | straight/ | 14 | 1 | 2 | 2/2 | 2/2 | 0/50 | combo line + | laser |
| | s-curve | | | | | | | wave | |

TABLE 3

| | | Repeat | Number of | Number of | | Bridge | Bridge | | |
|---|---|---|---|---|---|---|---|---|---|
| | | longitudinal | openings | openings | Strand | regions | region | Variation | |
| FIG. | Opening | direction | longitudinal | width | width | longitudinal | offset | from | Method of |
| Number | shape | [mm] | repeat | repeat | [mm] | direction[mm] | [%] | standard | Making |
| 16 | Straight | 13 | 2 | 2 | 7/7 | 1/1 | 0/50 | perpendicular | laser |
| | | | | | | | | lines | |
| 17 | Arc | 55 | 6 | 1 | 5 | 4/6/5/6/6/6 | 0/30/50/60/75/90 | repeated radially | laser |
| 18 | H | 19 | 2 | 2 | 3/3 | 3/3 | 0/50 | perpendicular | laser |
| | | | | | | | | different shapes | |
| 19 | asterisk | 22 | 1 | 2 | 3/3 | 3/3 | 0/75 | 6 point shape | laser |

A number of implementations and embodiments have been described. For instance, reticulated vapor permeable reflective material having reflective regions and non-reflective regions has been described. Thermal decay and vapor permeability through the reticulated vapor permeable reflective material is substantially the same as thermal decay and vapor permeability through the underlying material that does not include reticulated vapor permeable reflective material.

Nevertheless, it is understood that various modifications can be made without departing from the spirit and scope of this disclosure. For example, the reticulated vapor permeable reflective material could be included in as part of any garment to provide reflectively in the garment and yet also provide adequate thermal decay and vapor permeability through the garment. In addition, the reticulated vapor permeable reflective material could substantially or completely cover a garment or article. Also, the reflective material may be made florescent to enhance daytime visibility. In addition, alternative methods may be used to realize reticulated vapor permeable reflective material. For example, various different graphic screen printing techniques, electronic digital printing techniques, plotter cutting, laser cutting, or die cutting of reflective substrates to be applied on a material, or other similar techniques may be used to realize reticulated vapor permeable reflective material. Accordingly, other implementations and embodiments are within the scope of the following claims.

1. A reticulated reflective article, comprising:
a plurality of strands of a reflective material attached to one another at bridging regions in the reflective material and separable from one another between the bridging regions to provide openings in the reflective material, wherein the openings are expandable to provide a variably expandable area, and wherein the reflective materials comprises a reflective major surface and a non-reflective major surface,
wherein each of the openings has a longitudinal dimension, a width dimension, and each of the plurality of strands has a thickness, and
wherein the reticulated reflective article is expandable in at least both of a longitudinal direction and a width direction.

2. The article of claim 1, wherein the article provides a first reflective brightness when separated into a first width dimension between the plurality of strands of reflective material and a second reflective brightness when separated into a second width dimension between the plurality of strands of reflective material.

3. The article of claim 2, wherein the reduction in brightness between the first reflective brightness and the second reflective brightness is from at least about 10% reduction in brightness to about a 90% reduction in brightness, wherein both brightnesses are determined according to ASTM E810-03 (2013) when performed on unwashed reticulated reflective articles.

4. The article of claim 2, wherein the change in open area from the first width dimension to the second width dimension is at least 20%, the reduction in brightness between the first reflective brightness and the second reflective brightness is from at least 25% reduction in brightness to about a 90% reduction in brightness, wherein both brightnesses are determined according to ASTM E810-03 (2013) when performed on unwashed reticulated reflective articles, and further wherein the reticulated reflective article has a permeability of at least 5.5 cm/s.

5. The article of claim 2, wherein the article provides a first reflective brightness when separated into a first width dimension between the plurality of strands of reflective material having an adhesive layer disposed thereon and a second reflective brightness when separated into a second width dimension between the plurality of strands of reflective material having an adhesive layer disposed thereon.

6. The article of claim 3, and wherein the first width dimension is less than the second width dimension.

7. The article of claim 6, wherein the first reflective brightness is higher than the second reflective brightness.

8. The article of claim 1, wherein non-reflective regions comprise at least 25% of the total surface area of the reflective material.

9. The article of claim 1, wherein non-reflective regions comprise at least 50% of the total surface area of the reflective material.

10. The article of claim 1, further comprising a carrier tape adhered to the reflective major surface of the reflective material.

11. The article of claim 1 further comprising an adhesive layer disposed on one of the major surfaces of the reflective material, wherein the adhesive layer is separable into a plurality of strands disposed on the plurality of strands of the reflective material.

12. The article of claim 2, further comprising a substrate disposed on a major surface of the adhesive layer opposite the reticulated reflective article.

13. The article of claim 12, wherein the substrate is elastomeric.

14. The article of claim 12, wherein the article has a first brightness when it is in a non-expanded form and a second brightness when it is in an expanded form.

15. The article of claim 12, wherein the article has a first permeability when it is in a non-expanded form and a second permeability when it is in an expanded form.

16. The article of claim 1, wherein the reflective material is selected from at least one of optical films, microprismatic film and microsphere films.

17. A reticulated reflective article, having a longitudinal direction and a width direction, and comprises:
a plurality of regions of a reflective material separable from one another to provide openings in the reflective material, wherein the reflective materials comprises a reflective major surface and a non-reflective major surface,
wherein each of the openings has a longitudinal dimension, and a width dimension, and
wherein the reticulated reflective article is expandable in at least two directions.

18. The article of claim 17 further comprising a multitude of the plurality of regions extending radially from a common intersection.

19. The article of claim 17, wherein the article provides a first reflective brightness when separated into a first width dimension between the plurality of regions of reflective material and a second reflective brightness when separated into a second width dimension between the plurality of regions of reflective material.

20. The article of claim 19, wherein the reduction in brightness between the first reflective brightness and the second reflective brightness is from about 10% reduction in brightness to about a 90% reduction in brightness, wherein both brightnesses are determined according to ASTM E810-03 (2013) when performed on unwashed reticulated reflective articles.

21-34. (canceled)
